(19) United States
(12) Patent Application Publication
(10) Pub. No.: US 2015/0213393 A1
(43) Pub. Date: Jul. 30, 2015

(54) METHODS AND SYSTEMS FOR PRESENTING TASK INFORMATION TO CROWDWORKERS

(71) Applicant: Xerox Corporation, Norwalk, CT (US)

(72) Inventors: Jacki O'Neill, Bangalore (IN); Shourya Roy, Bangalore (IN); David Martin, Grenoble (FR)

(73) Assignee: Xerox Corporation, Norwalk, CT (US)

(21) Appl. No.: 14/164,313

(22) Filed: Jan. 27, 2014

(51) Int. Cl. G06Q 10/06

(52) U.S. Cl. CPC G06Q 10/063114; G06Q 10/063112

(57) ABSTRACT

Methods and systems for presenting a task information to a crowdworker. One or more tasks, performed by the crowdworker, are monitored. A historical task information pertaining to the one or more tasks, performed by the crowdworker, is determined based on the monitoring. Further, a predicted task information is determined based on the historical task information. The predicted task information is utilizable by the crowdworker to select one or more future tasks. The predicted task information includes at least one of a count of the one or more future tasks available for the crowdworker, estimated time to attempt the one or more future tasks, or wages associated with the one or more future tasks. At least one of the historical task information or the predicted task information is presented to the crowdworker.

### TECHNICAL FIELD

The presently disclosed embodiments are related, in general, to crowdsourcing. More particularly, the presently disclosed embodiments are related to methods and systems for presenting task information to crowdworkers.

### BACKGROUND

Crowdsourcing has emerged as a convenient and an economical method for organizations to outsource certain tasks, which require human involvement. For example, tasks such as digitization of a handwritten document, labeling of an image, and anomaly detection in video may be uploaded by a requester on one or more crowdsourcing platforms. Crowdworkers associated with the crowdsourcing platforms may attempt such tasks.

Existing crowdsourcing platforms or service providers provide various solutions to the requesters to assess or select the crowdworkers to perform the tasks. For example, such solutions may enable the requesters to assess the crowdworkers by an evaluation test or by analyzing the crowdworker's previous performance metrics. Further, some solutions recommend one or more crowdworkers for one or more tasks based on the skill sets of the crowdworkers.

However, it will be beneficial for the crowdworkers to get similar information from the crowdsourcing platforms. For example, since a crowdworker generally works for many requesters and on many types of jobs, it can be difficult for the crowdworkers to take the best decisions on which requesters to work for and which types of jobs to attempt.

### SUMMARY

According to embodiments illustrated herein, there is provided a method for presenting a task information to a crowdworker. The method includes monitoring one or more tasks performed by the crowdworker; determining a historical task information pertaining to the one or more tasks performed by the crowdworker, based on the monitoring; and determining a predicted task information based on the historical task information, the predicted task information being utilizable by the crowdworker to select one or more future tasks. The predicted task information includes at least one of a count of the one or more future tasks available for the crowdworker, estimated time to attempt the one or more future tasks, or wages associated with the one or more future tasks. The method further includes presenting at least one of the historical task information or the predicted task information to the crowdworker. The method is performed by one or more processors.

According to embodiments illustrated herein, there is provided a system for presenting a task information to a crowdworker. The system includes one or more processors operable to monitor one or more tasks performed by the crowdworker; determine a historical task information, pertaining to the one or more tasks performed by the crowdworker, based on the monitoring; and determine a predicted task information based on the historical task information, the predicted task information being utilizable by the crowdworker to select one or more future tasks. The predicted task information includes at least one of a count of the one or more future tasks available for the crowdworker, estimated time to attempt the one or more future tasks, or wages associated with the one or more future tasks. The one or more processors are further operable to present at least one of the historical task information or the predicted task information to the crowdworker.

According to embodiments illustrated herein, there is provided a computer program product for use with a computer. The computer program product includes a non-transitory computer readable medium. The non-transitory computer readable medium stores a computer program code for presenting a task information to a crowdworker. The computer program code is executable by one or more processors to monitor one or more tasks performed by the crowdworker; determine a historical task information, pertaining to the one or more tasks performed by the crowdworker, based on the monitoring; and determine a predicted task information based on the historical task information, the predicted task information being utilizable by the crowdworker to select one or more future tasks. The predicted task information includes at least one of a count of the one or more future tasks available for the crowdworker, estimated time to attempt the one or more future tasks, or wages associated with the one or more future tasks. The computer program code is further executable by one or more processors to present at least one of the historical task information or the predicted task information to the crowdworker.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a system for presenting a task information to a crowdworker, in accordance with at least one embodiment;

FIG. 3 is a flowchart illustrating a method for presenting a task information to a crowdworker, in accordance with at least one embodiment;

FIG. 4 is a flowchart illustrating a method for determining historical task information, in accordance with at least one embodiment; and

FIG. 5 is a block diagram illustrating the historical task information and predicted task information in a crowdworker-widget, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

“Crowdsourcing” refers to distributing tasks by soliciting the participation of groups of users. A group of users may include, for example, individuals responding to a solicitation posted on a certain website (e.g., crowdsourcing platform), such as Amazon Mechanical Turk or Crowd Flower.

A “crowdsourcing platform” refers to a business application, wherein a broad, loosely defined external group of people, community, or organization provides solutions as outputs for any specific business processes received by the application as input. In an embodiment, the business application may be hosted online on a web portal. Various examples of the crowdsourcing platforms include, but are not limited to, Amazon Mechanical Turk or Crowd Flower.

A “crowdworker” refers to a worker or a group of workers that may perform one or more crowdsourcing tasks that generate data that contribute to a defined result, such as proofreading part of a digital version of an ancient text or analyzing a small quantum of a large volume of data. Hereinafter, “remote worker”, “worker”, “crowdsourced workforce,” “crowdworker,” “crowd workforce,” and “crowd” may be interchangeably used.

A “widget” refers to an application/tool/framework having an interface that enables a user to perform a function or access a service on a computing device (e.g., a computer, laptop, PDA, smart-phone, etc.). The widget may include buttons, dialogue boxes, pop-up windows, pull-down menus, scroll bars, icons, etc., which the user may use to perform the function or access the service. In an embodiment, the widget may be installed on the computing device.

A “crowdworker-widget” refers to a widget that can be installed on a computing device associated with a crowdworker. In an embodiment, the crowdworker-widget may include one or more programmable APIs that may collect information about tasks being performed by the crowdworker on the computing device. In an embodiment, the crowdworker-widget may receive information pertaining to the tasks performed by other crowdworkers associated with the crowdsourcing platform. Further, the crowdworker-widget may present the information on a display device associated with the crowdworker.

“Remuneration” refers to rewards received by the one or more crowdworkers for attempting/submitting the one or more tasks. The remuneration may include one or more forms of monetary rewards, such as, but not limited to, cash, gift cards, gift coupons and so forth. Further, in an embodiment, the remuneration may include non-monetary forms of the rewards. For example, the remuneration may include strengthening the relationship between the crowdworkers and the requesters, or the prospects of better rewards on completion of the one or more tasks.

“Wages” refer to remuneration offered to the crowdworkers for the one or more tasks attempted/submitted by the crowdworkers. In an embodiment, the wages offered to the crowdworkers are determined based on time spent by the crowdworkers on the one or more tasks. For example, the crowdworkers may be offered remuneration based on per-minute or per-hour spent on the one or more tasks. In another embodiment, the remuneration may gradually increase with increase in the number of tasks attempted by the crowdworker. In another example, the crowdworker may receive a flat remuneration for accepting the task and post acceptance, the crowdworker may receive remuneration on hourly/minute basis.

“Historical task information” refers to information pertaining to one or more tasks that have already been attempted by the crowdworkers. For example, information, such as time spent by the crowdworkers on the one or more tasks, a count of the one or more tasks, wages earned/offered for the one or more tasks, types of the one or more tasks (e.g., digitization, translation, labeling, etc.), etc., may constitute the historical task information. Further, information about the requesters and the crowdsourcing platforms may also be included in the historical task information.

“Future tasks” refer to one or more crowdsourcing tasks that may be attempted by the crowdworkers. In an embodiment, the crowdworkers use the historical task information (presented by the crowdworker-widget) to select the one or more future tasks. For example, a crowdworker may select the future tasks for a requester, which has provided best earnings to the crowdworker.

“Predicted task information” refers to a predictive information about the one or more future tasks that are to be attempted by the one or more crowdworkers. For example, information such as a count of the one or more future tasks available for the crowdworkers, predicted/estimated time to attempt the one or more future tasks, predicted number of work hours available for a requester, and estimated wages for the one or more future tasks may constitute the predicted task information. In an embodiment, the predicted task information may be determined (i.e., predicted) based on the historical task information.

For the ongoing disclosure “historical task information” and “predicted task information”, are collectively referred to as the “task information.”

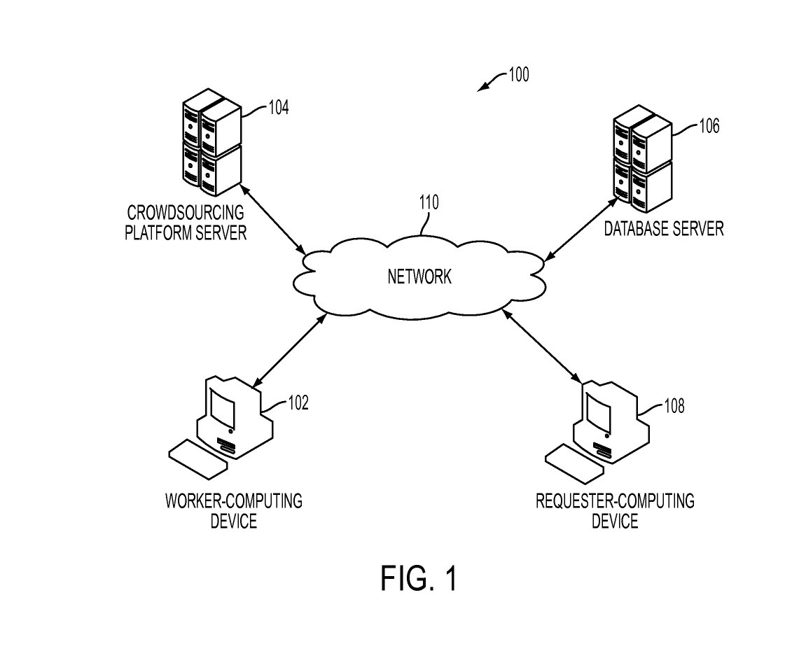

FIG. 1 is a block diagram illustrating a system environment 100 in which various embodiments may be implemented. The system environment 100 includes a worker-computing device 102, a crowdsourcing platform server 104, a database server 106, a requester-computing device 108, and a network 110. The worker-computing device 102, the crowdsourcing platform server 104, the database server 106, and the requester-computing device 108 are interconnected over the network 110.

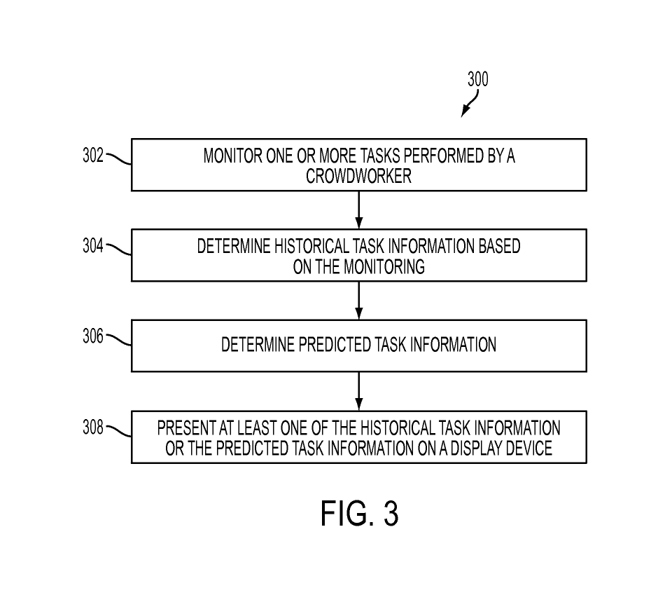

The worker-computing device 102 refers to a computing device, used by one or more crowdworkers, to perform one or more tasks. In an embodiment, the worker-computing device 102 receives a user interface (UI) from the crowdsourcing platform server 104. The one or more tasks may be presented to the crowdworker through the UI. The crowdworker may submit the response through the UI. Further, a crowdworker-widget may be installed on the worker-computing device 102. In an embodiment, the crowdworker-widget may be received on the worker-computing device 102 from the crowdsourcing platform server 104. The crowdworker-widget may monitor the tasks being performed by the crowdworker on the worker-computing device 102 to determine the historical task information. The crowdworker-widget may transmit the historical task information to the crowdsourcing platform server 104. Further, based on the historical task information, the crowdworker-widget may determine a predicted task information. The crowdworker-widget may present the historical task information and the predicted task information on a display device associated with the worker-computing device 102. The operation of the crowdworker-widget has been described later in conjunction with FIG. 3. The worker-computing device 102 may include a variety of computing devices, such as a desktop, a laptop, a personal digital assistant (PDA), a tablet computer, and the like.

The crowdsourcing platform server 104 may refer to a device or a computer that hosts one or more crowdsourcing platforms. The crowdsourcing platform server 104 may communicate the one or more tasks to the one or more crowdworkers associated with the crowdsourcing platform. In an embodiment, the crowdsourcing platform server 104 presents a user interface (UI) to the one or more crowdworkers through a web based interface or a client application. The one or more crowdworkers may access the one or more tasks through the web based interface or the client application. Further, the one or more crowdworkers may submit a final response for the task to the crowdsourcing platform server 104 through the web based interface. In an embodiment, the crowdsourcing platform server 104 may transmit the crowdworker-widget to the worker-computing device 102 for installation of the crowdworker-widget. Further, in an embodiment, the crowdsourcing platform server 104 may transmit the information pertaining to the one or more tasks to the one or more worker-computing devices 102. Based on the received information, the crowdworker-widget may determine the historical and the predicted task information corresponding to the one or more crowdworkers. Further, in an embodiment, the crowdsourcing platform server 104 may transmit the historical task information and the predicted task information, received from the one or more worker-computing devices 102, to the database server 106. The crowdsourcing platform server 104 may be realized through an application server such as, but not limited to, Java application server, .NET framework, and Base4 application server.

The database server 106 may refer to a device or a computer that maintains a repository of the tasks assigned to the crowdworkers. In an embodiment, the database server 106 may store the historical task information or the predicted task information. The database server 106 may receive the historical task information or the predicted task information from the crowdsourcing platform server 104. Further, the database server 106 may receive a query from the crowdsourcing platform server 104 to retrieve the historical task information or the predicted task information. For querying the database server 106, one or more querying languages may be utilized such as, but are not limited to, SQL, QUEL, DMX and so forth. Further, the database server 106 may be realized through various technologies, such as, but not limited to, Microsoft® SQL server, Oracle, and My SQL. In an embodiment, the crowdsourcing platform server 104 may connect to the database server 106 using one or more protocols such as, but not limited to, ODBC protocol and JDBC protocol.

A person skilled in the art would understand that the scope of the disclosure should not be limited to the database server 106 as a separate entity. In an embodiment, the functionalities of the database server 106 and the crowdsourcing platform server 104 may be combined into a single server, without departing from the scope of the disclosure.

The requester-computing device 108 may refer to a computing device, used by the requester, to upload information pertaining to one or more tasks. In an embodiment, the requester may access the crowdsourcing platform server 104 to upload the information pertaining to one or more tasks. For example, if the crowdsourcing tasks correspond to digitization of handwritten documents, the requester may upload electronic documents (e.g., scanned copies of the handwritten document) on the crowdsourcing platform server 104. The requester-computing device 108 may include a variety of computing devices, such as a desktop, a laptop, a personal digital assistant (PDA), a tablet computer, and the like.

The network 110 corresponds to a medium through which content and messages flow between various devices of the system environment 100 (e.g., the worker-computing device 102, the crowdsourcing platform server 104, the database server 106, and the requester-computing device 108). Examples of the network 110 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 110 in accordance with the various wired and wireless communication protocols such as Transmission Control Protocol and Internet Protocol (TCP/IP), User Datagram Protocol (UDP), and 2G, 3G, or 4G communication protocols.

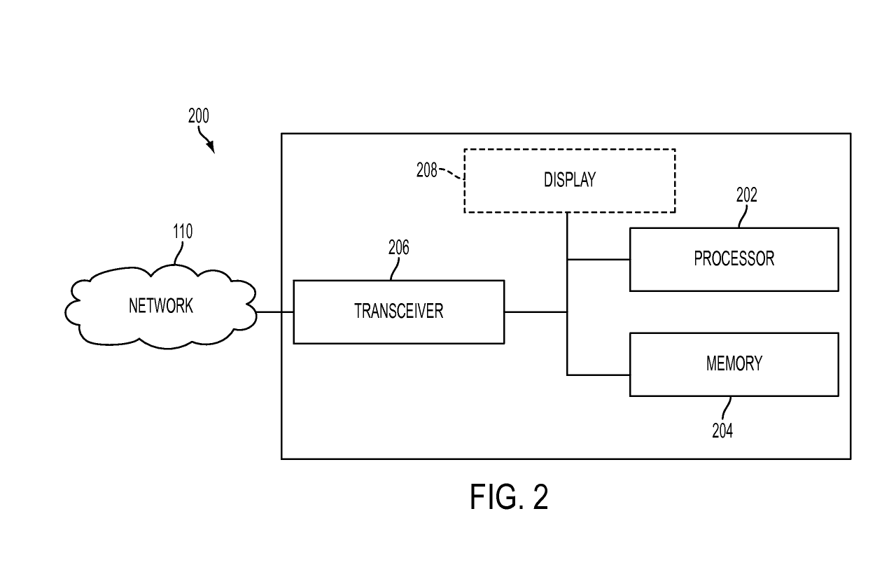

FIG. 2 is a block diagram illustrating a system 200 for presenting the task information to the crowdworker, in accordance with at least one embodiment. The system 200 includes a processor 202, a memory 204, a transceiver 206, and a display 208. For the ongoing disclosure, the system 200 corresponds to the worker-computing device 102.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but are not limited to, an X86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person having ordinary skills in the art that the one or more instructions stored in the memory 204 enables the hardware of the system 200 to perform the predetermined operation.

The transceiver 206 transmits and receives messages and data to/from various components of the system environment 100 (e.g., the worker-computing device 102, the crowdsourcing platform server 104, the database server 106, and the requester-computing device 108). Examples of the transceiver 206 may include, but are not limited to, an antenna, an Ethernet port, an USB port or any other port that can be configured to receive and transmit data. The transceiver 206 transmits and receives data/messages in accordance with the various communication protocols, such as, TCP/IP, UDP, and 2G, 3G, or 4G communication protocols.

The display 208 displays the task information to the crowdworker. The display 208 can be realized through several known technologies, such as, Cathode Ray Tube (CRT) based display, Liquid Crystal Display (LCD) based display, Light Emitting Diode (LED) based display, Organic LED based display, and Retina technology based display. In an embodiment, the display 208 can be a touch screen that is operable to receive a user-input.

The operation of the system 200 for presenting the task information to the crowdworker has been described in conjunction with FIG. 3.

FIG. 3 is a flowchart 300 illustrating a method for presenting the task information to the crowdworker, in accordance with at least one embodiment. In an embodiment, the method for presenting the task information is implemented on the worker-computing device 102. The flowchart 300 is described in conjunction with FIG. 1 and FIG. 2.

At step 302, the one or more tasks performed by the crowdworker are monitored. Prior to monitoring the one or more tasks, the processor 202 installs the crowdworker-widget on the worker-computing device 102. In an embodiment, the crowdworker-widget may be received from the crowdsourcing platform server 104. In addition, the processor 202 may receive the UI from the crowdsourcing platform server 104. The UI is presented to the crowdworker through the display 208. The user may access/perform the one or more tasks through the UI. The crowdworker-widget monitors the one or more tasks, being performed by the crowdworker, through one or more programmable APIs in order to collect information pertaining to the one or more tasks.

A person having ordinary skill in the art would understand that the scope of the disclosure is not limited to receiving the crowdworker widget from the crowdsourcing platform server 104. In an alternate embodiment, the crowdworker-widget may be received from other sources and may be manually downloaded/installed by the crowdworkers on the respective worker-computing devices 102.

In an embodiment, the information pertaining to the one or more tasks includes information associated with the tasks accepted/submitted/returned by the crowdworker, information associated with the performance of the crowdworker etc. In an embodiment, the tasks accepted by the crowdworker corresponds the tasks that the crowdworker has accepted to attempt. The crowdworker may have selected the task being presented to her on the user interface. Further, submitted tasks correspond to tasks for which the crowdworker has submitted the response. Furthermore, the returned tasks correspond to tasks that crowdworker did not wish to complete.

In an embodiment, the information associated with the tasks may include information pertaining to types of the tasks, wages associated with the tasks, requestors associated with the tasks, or crowdsourcing platforms associated the tasks. For example, the crowdworker attempts five tasks out of which, the crowdworker submits three tasks after completion and returns the remaining two tasks. The crowdworker-widget may determine and record the count of accepted/submitted/returned tasks, the types of the accepted/submitted/returned tasks, the wages associated with the accepted/submitted/returned tasks, the requestors associated with the accepted/submitted/returned tasks, and the crowdsourcing platforms associated with the accepted/submitted/returned tasks. The following Table 1 illustrates information collected by the crowdworker-widget:

TABLE 1
Illustration of the collected information by the crowdworker-widget

| | | | Wages | | |
|---|---|---|---|---|---|
| | Accep- | | of | | |
| | tance | Type | the task | | Crowdsourcing |
| Tasks | status | of task | (USD) | Requestor | platform |
| Task-1 | Submitted | Image | 5 | Requestor-1 | Platform-1 |
| | | processing | | | |
| Task-2 | Returned | Anomaly | 0.5 | Requestor-1 | Platform-2 |
| | | detection | | | |
| Task-3 | Submitted | Image | 3 | Requestor-1 | Platform-4 |
| | | processing | | | |
| Task-4 | Submitted | Anomaly | 2 | Requestor-2 | Platform-3 |
| | | detection | | | |
| Task-5 | Returned | Document | 2 | Requestor-3 | Platform-4 |
| | | digi- | | | |
| | | tization | | | |

Further, the information may include information associated with the performance of the crowdworker in attempting the tasks. The crowdworker-widget maintains a counter of a number/count of the tasks attempted by the crowdworkers. In addition, the crowdworker-widget maintains a record of the time spent by the crowdworker on each of the one or more tasks.

The crowdworker-widget may store the information pertaining to the one or more tasks in the memory 204. In an embodiment, the information may be stored in the database server 106 for later retrieval. Information collected by the crowdworker-widget may be used to derive the historical task information.

In an embodiment, the crowdworker-widget may operate in two modes: individual mode and collective mode. The crowdworker may select either of the two modes before or during attempting the one or more tasks. In an embodiment, the selection of the modes may be performed by an interface provided on the crowdworker-widget. In the individual mode, the crowdworker-widget collects the information from the worker-computing device 102, on which the crowdworker-widget is installed.

In the collective mode, the crowdworker-widget may collect the information from the multiple worker-computing devices 102 corresponding to a set of the crowdworkers. In an embodiment, the crowdworker-widget may collect the information through the crowdsourcing platform server 104. In an alternate embodiment, the crowdworker-widget may collect the information directly from the other worker-computing devices 102 (e.g., when the one or more worker-computing devices 102 are connected through a peer-to-peer network).

In an embodiment, the crowdworker may modify the mode of the crowdworker-widget at any moment of time. For instance, the crowdworker-widget is initially configured to operate in the individual mode. As discussed above, in the individual mode, the crowdworker-widget collects the information only from the worker-computing device 102A on which the crowdworker-widget is installed. However, the crowdworker may activate the collective mode after attempting a set of the tasks, after which the information may be collected for the set of the crowdworkers.

In an embodiment, the set of the crowdworkers may include all those crowdworkers who have enabled the collective mode on their respective worker-computing devices 102. In an alternate embodiment, the set of crowdworkers may be a subset of the crowdworkers who have enabled the collective mode. For instance, the crowdworker may manually define the names of the crowdworkers for defining the set of crowdworkers, for whom information collection is required. In an embodiment, the crowdworker may define the names using the interface provided on the crowdworker-widget.

In an alternate embodiment, the set of the crowdworkers for the collective mode may be defined by comparing the profile information (such as demographic details, educational details, etc.) of the crowdworkers. For example, the crowdsourcing platform server 104 may compare the profile information for various crowdworkers associated with the one or more worker-computing devices 102 and may subsequently cluster the crowdworkers in the set of crowdworkers based on the similar profile information. In this way, the crowdsourcing platform server 104 transmits the information pertaining to the one or more tasks attempted by each crowdworker from the set of crowdworkers to the worker-computing device 102, on which the crowdworker-widget is installed. In an alternate embodiment, the crowdworker-widget may compare the profile information for the one or more crowdworkers. In such a scenario, the crowdworker-widget may receive the profile information from the crowdsourcing platform server 104 and may subsequently compare the profile information.

In an embodiment, the set of the crowdworkers may be automatically populated based on contacts of the crowdworker on one or more social networking websites such as Facebook®, Twitter®, LinkedIn®, Google+®, Hotmail®, etc. The crowdworker-widget may access the contacts of the crowdworker while the crowdworker accesses the one or more social networking sites using the worker-computing device 102. In an alternate embodiment, the crowdworker-widget may obtain the contacts from the crowdsourcing platform server 104. It will be apparent to a person having ordinary skill in the art that various other methods may also be used to define the set of the crowdworkers, for which monitoring (i.e., collection of the information) is desired.

Further, the crowdworker-widget may prompt the crowdworker to edit the collected information. For example, the information collected by the crowdworker-widget may be cumulative and thus may not take into account the breaks or interruptions of the crowdworker while the crowdworker performed the tasks. Thus, in such a scenario, the crowdworker may be prompted to edit the collected task information. For example, if the crowdworker-widget observes that the time taken by the crowdworker is substantially different from the average time taken by the crowdworker to complete similar tasks, it may prompt the crowdworker to edit the information. On being prompted, the crowdworker may edit the collected information taking into account the breaks/interruptions incurred by her. For example, if the crowdworker observes that the time determined by the crowdworker-widget for a task to complete is 10 minutes, whereas the task is worked on for 2 minutes only, the crowdworker may edit the information in such a scenario. Thus, in this way, the crowdworker-widget monitors the information for any possible outliers and no such outlier gets into the determination of the information.

In an embodiment, the crowdworker is allowed to edit only the information pertaining to the one or more tasks attempted by her. The crowdworker is not allowed to edit information pertaining to the one or more tasks attempted by the set of crowdworkers.

At step 304, the historical task information is determined based on the monitoring. The information pertaining to the one or more tasks, as disclosed in the step 302, may be used to determine the historical task information. The crowdworker-widget may use one or more arithmetic operations and DBMS techniques, known in the art, to obtain and subsequently structure the historical task information pertaining to the one or more tasks. It will be apparent to a person having ordinary skill in the art that the historical task information includes the same information as the information collected during the step 302 and the all the previous tasks attempted by the crowdworker prior to attempting the one or more tasks. In an embodiment, the historical task information may include hourly, daily, or monthly wages, represented in a tabular or graphical form and determined on the basis of the information corresponding to the wages, as collected in the step 302. In an embodiment, the historical task information is extracted from the database server 106. Below is provided a detailed description of determination of various types of the historical task information:

### Determination of Time Spent by the Crowdworker on the One or More Tasks

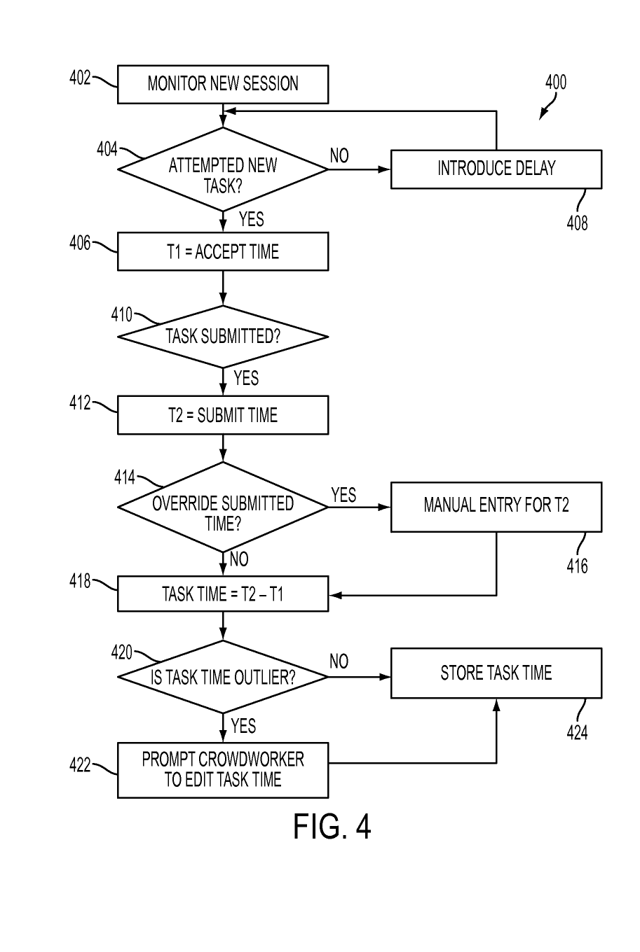

In order to determine the time spent by the crowdworker on a task, the crowdworker-widget records a first timestamp at which the crowdworker accepted the task. Further, the crowdworker-widget records a second timestamp at which the crowdworker submitted the response for the task. The crowdworker-widget may store all such timestamps in the memory 204. Further, the crowdworker-widget may transmit such information to the crowdsourcing platform server 104. For determining the time spent on the task, the crowdworker-widget may extract all such timestamps associated with each of the one or more tasks attempted by the crowdworker. Based on all such timestamps, the crowdworker-widget may determine the difference between the first timestamp (i.e., time of acceptance of a task) and second timestamp (i.e., time of submission of the task) to determine the time spent by the crowdworker on each of the one or more tasks. Further, the crowdworker-widget may determine an average time taken by the crowdworker to attempt the one or more tasks. A person having ordinary skills in the art would understand that the average time (or any other possible statistical manipulation of the determined time stamps) spent by the crowdworker to attempt the one or more tasks can be determined for each type of task, for each requestor, and for each crowdsourcing platform. The determination of the time spent on the one or more tasks has been further illustrated later in conjunction with FIG. 4.

Based on the average time spent by the crowdworker on each of the one or more tasks, the crowdworker-widget may determine a learning curve of the crowdworker. For example, the crowdworker-widget may determine the average time spent by the crowdworker on the tasks attempted on the one or more crowdsourcing platforms or for the one or more requestors. Thereafter, the crowdworker-widget may plot the average time taken by the crowdworker on the tasks in a graphical form. In an embodiment, the learning curve is indicative of the reduction in the time taken by the crowdworker to complete the one or more tasks.

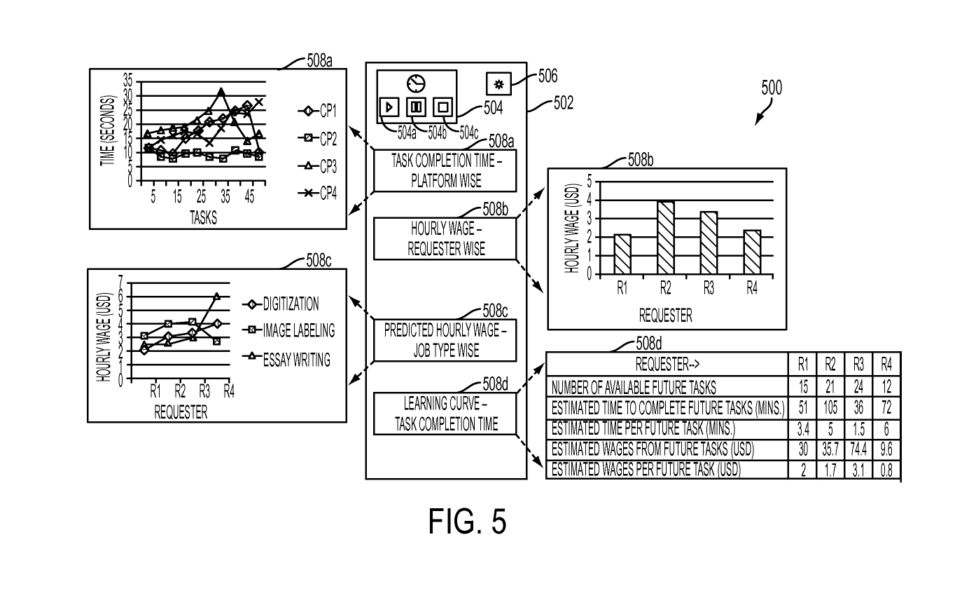

In an embodiment, a curve may be presented with respect to the wages earned by the crowdworker. By observing the curve, the crowdworker may analyze her progress, in terms of the wages earned. An example graph has been illustrated in FIG. 5.

### Determination of Count of the One or More Tasks

As described in conjunction with step 302, the crowdworker-widget maintains the count of tasks attempted by the crowdworker. Further, the crowdworker-widget maintains the breakup of the count of tasks for each type of the tasks that the crowdworker has attempted, the count of the tasks from each requestor, and the count of the tasks from each crowdsourcing platform. In an embodiment, the crowdworker-widget may represent this information, pertaining to the count of the tasks, in a graphical form. An example of the count of tasks has been described in conjunction with FIG. 5.

### Determination of Wages for the One or More Tasks

As discussed, in conjunction with the step 302, the crowdworker-widget monitors the wages earned by the crowdworker while performing the tasks. As the crowdworker receives payments from the requesters through the worker-computing device 102, the crowdworker-widget may extract the information pertaining to the wages earned by the crowdworker. The crowdworker-widget may store the information pertaining to the wages in the memory 204. Further, the crowdworker-widget may transmit the information pertaining to the wages to the crowdsourcing platform server 104, from where the information may be stored in the database server 106. Using the information pertaining to the wages, the crowdworker-widget may determine the wages earned by the crowdworker for each day. In a similar way, the crowdworker-widget may determine the wages earned by the crowdworker for any time interval, as defined by the crowdworker. For example, in an embodiment, the crowdworker-widget may utilize the following equation to determine the hourly wage:

$$Hourly wage = \frac{Total amount of wages earned by the crowdworker}{Number of hours worked} \qquad ( 1 )$$

In addition to the hourly wage, the crowdworker-widget may determine the distribution of the total wages earned by the crowdworker for each of the types of the tasks, for each of the one or more requestors, and for each of the one or more crowdsourcing platforms. For example, the crowdworker-widget may determine the wages earned by the crowdworker from a particular requester. Further, the wages earned from the requester may be determined on hourly, daily, weekly, or monthly, basis. Similarly, the crowdworker-widget may determine the wages earned by the crowdworker for a particular type of the task or the wages earned by the crowdworker from a particular crowdsourcing platform on an hourly, daily, weekly, or monthly basis. An illustration of the historical information corresponding to the wages for the one or more tasks has been provided in conjunction with the FIG. 5.

### Determination of the Types of Tasks

As discussed above, the crowdworker-widget may determine the types of tasks attempted/submitted/returned by the crowdworker. The crowdworker-widget may determine various types of the tasks, such as but not limited to, image/video/text labelling/tagging/categorisation, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g. of product placement), text/image analysis, directory compilation, information search/retrieval and so forth. As disclosed above, for each of the types of the tasks that the crowdworker has accepted/submitted/returned, the crowdworker-widget may determine the count of the tasks, wages earned from the tasks, the time spent on the tasks. In an embodiment, the crowdworker-widget may determine information pertaining to the acceptance or rejection, by the requesters, of the submitted/returned tasks. Further, the crowdworker-widget may determine a distribution, of each of the types, among the one or more crowdsourcing platforms and the one or more requesters. The crowdworker-widget may present this information in a graphical or a tabular form. An illustration of the historical information pertaining to the types of the one or more tasks is provided in the FIG. 5.

### Determination of Information Pertaining to the Requesters

As discussed, the crowdworker-widget may determine various types of information pertaining to the requesters associated with the one or more tasks performed by the crowdworker. For example, for each of the requesters, the crowdworker-widget may determine the count of the one or more tasks, the time spent on the one or more tasks, the types of the one or more tasks, and the wages earned from the one or more tasks. In an embodiment, the crowdworker-widget may determine the information pertaining to the acceptance/rejection by the requesters for the tasks submitted/returned by the crowdworkers. Based on the various types of the information pertaining to the requesters, the crowdworker-widget may rank or assign ratings to the one or more requestors for the crowdworker. The following table illustrates historical task information including information pertaining to the one or more requestors:

TABLE 2
Illustration of the information pertaining to the requestors

| | | Average | Time spent | | |
|---|---|---|---|---|---|
| | Number of | wage offered | by the | | Number of |
| | tasks | by the | crowdworker | Time spent | tasks |
| | submitted by | requestor | on tasks | by the | rejected by |
| | the | (USD) for | from | crowdworker | the |
| Requestor | crowdworker | each task | requestor | per task | requester |
| Requestor-1 | 10 | 1.5 | 60 min | 6 min | 1 |
| Requestor-2 | 5 | 1 | 5 min | 1 min | 1 |
| Requestor-3 | 15 | 0.7 | 30 min | 2 min | 4 |

Referring to Table 2, it can be observed that 10 tasks from the requestor-1 were submitted by the crowdworker. Average wages offered by the requestor-1 on each task is 1.5 USD. In addition, the total time spent by the crowdworker to attempt the task is 60 minutes. Further, number of the tasks rejected by the requester-1 is 1 (out of 10 tasks submitted by the crowdworker). In comparison, five tasks from the requestor-2 were submitted by the crowdworker. Average wage offered by the requestor-2 on each task is 1 USD and the total time spent by the crowdworker to attempt the task is 5 minutes. Number of rejected tasks by the requester-2 is 1. As the requester-1 has offered more wages per task than the requester-2, more time has been spent by the crowdworker for requester-1 than the requester-2, and rejection rate (e.g., number of rejected tasks per task submitted by the crowdworker) is higher for the requester-2, the crowdworker-widget may give a higher ranking to the requester-1 than requester-2. In a similar way, the crowdworker-widget may categorize the requesters as good requesters or bad requesters based on the determined historical task information pertaining to the one or more requesters.

A person having ordinary skill in the art would understand that the rating/ranking of the one or more requestors might be different for different crowdworkers. For instance, a second crowdworker may have spent more time for the tasks from requestor-2 in comparison to the tasks from the requestor-1 and may have earned more wages from requestor-2 in comparison to the wages from requestor-1. In such a case, the crowdworker widget, installed in the worker-computing device 102 of the second crowdworker, may give a higher ranking to the requester-2 than requester-1 for the second crowdworker.

In an embodiment, the crowdworker-widget may receive the information about the requester's reputation from various sources, such as crowdsourcing platforms, plug-ins, internet rating sites (e.g., Turkopticon) etc. and may present the information to the crowdworker. The information pertaining to the requesters may be presented to the crowdworker in tabular or graphical form. Analyzing this information, the crowdworker may plan for attempting the one or more future tasks.

### Determination of Information Pertaining to the Crowdsourcing Platforms

The crowdworker-widget may determine various types of the information pertaining to the crowdsourcing platforms associated with the one or more tasks attempted/submitted/returned by the crowdworker. As discussed, for each of the crowdsourcing platforms that the crowdworker has worked on, the crowdworker-widget may determine count of the one or more tasks, time spent on the one or more tasks, wages earned from the one or more tasks, and the types of the one or more tasks. Table 3, provided below, illustrates information pertaining to the one or more crowdsourcing platforms, as determined by the crowdworker-widget:

TABLE 3
Illustration of the information pertaining to the one or more crowdsourcing platforms

| | Number of | Average number | Total time | Average time | Average wages | Maximum | Number of |
|---|---|---|---|---|---|---|---|
| | submitted | of daily | spent | per task | per task | attempted | tasks rejected |
| Platform | tasks | tasks | (hours) | (mins) | ($) | type | on the platform |
| CP-1 | 85 | 40 | 240 | 10 | 1 | Task | 5 |
| | | | | | | Digitization | |
| CP-2 | 75 | 50 | 360 | 8 | 1.5 | Anomaly | 7 |
| | | | | | | detection | |
| CP-3 | 90 | 60 | 480 | 6 | 2.0 | Image | 4 |
| | | | | | | labeling | |

As depicted in the above Table 3, various insights have been determined, which the crowdworker may utilize to attempt the one or more future tasks. For example, since out of the three crowdsourcing platforms that the crowdworker has worked on (i.e., CP-1, CP-2, and CP-3), the crowdworker earned maximum average wages per task from CP-3. Further, it can be observed that the rejection rate was minimum for CP-3 and the crowdworker spent least time per task on the CP-3. Therefore, it is likely that after being presented with the Table 3, crowdworker will want to attempt more of the future tasks on the platform CP-3. It will be apparent to a person skilled in the art that various other combinations of the information, not explicitly shown in the Table 3, can be added while determining the information pertaining to the one or more crowdsourcing platforms. Further, the information pertaining to the one or more crowdsourcing platforms may be presented in a graphical form, instead of a tabular one.

In an embodiment, various types of the historical information, as disclosed above, may be determined for both the modes (i.e., individual mode and collective mode). In individual mode, the historical information is determined for the worker-computing device 102, on which the crowdworker-widget is installed, whereas in collective mode, the information is determined for the set of the crowdworkers. The set of the crowdworkers may be determined/selected by various methods, as discussed in conjunction with step 302. Further examples and illustration of the historical task information have been discussed in conjunction with FIG. 5.

At step 306, predicted task information is determined. In an embodiment, the predicted task information is predictive information derived from the historical task information, such that the crowdworker may utilize the predicted task information to select one or more future tasks. Similar to the historical task information, various types of predictive task information may be determined by the crowdworker-widget, such as count of the one or more future tasks available, time available for the one or more future tasks, estimated wages from the one or more future tasks, types of the available one or more future tasks and so forth. Further, the predicted task information may be determined for each of the requesters and the crowdsourcing platforms, for which the crowdworker has worked.

Various types of the predicted task information, as determined by the crowdworker-widget is described below:

### Determination of the Predicted Task Information Pertaining to the One or More Requesters

Based on the historical task information pertaining to the one or more requesters, the crowdworker-widget may determine the predicted task information pertaining to the one or more requesters. In an embodiment, for each of the requesters that the crowdworker has worked for, the crowdworker-widget may determine a count of the one or more future tasks available for attempt, types of the one or more future tasks available for attempt, an estimated time to attempt the one or more future tasks, and estimated wages that can be earned from the one or more future tasks. For example, the crowdworker has worked for three requesters (refer Table 2). In such a scenario, Table 4 provided below illustrates the predicted task information pertaining to the three requesters, as determined by the crowdworker-widget:

TABLE 4
Illustration of the predicted task information pertaining to the one or more
requesters

| | | Estimated | Estimate |
|---|---|---|---|
| | Number of future | wages from | time available |
| | tasks available for | available future | for attempting future |
| Requester | attempt | tasks ($) | tasks (minutes) |
| Requestor-1 | 900 | 1200 | 5200 |
| Requestor-2 | 700 | 700 | 750 |
| Requestor-3 | 1050 | 790 | 2200 |

In an embodiment, the information pertaining to the number of future tasks available for attempt may be determined by the crowdworker-widget based on the information available on the crowdsourcing platform server 104. For example, for each of the requesters that the crowdworker has worker for, the crowdworker-widget may extract information about the available future tasks from the crowdsourcing platform server 104. In an alternate embodiment, the crowdworker-widget may determine a pattern of the number of the tasks corresponding to a particular requester and present the information to the crowdworker as the predicted task information.

The crowdworker-widget may also determine estimated wages that can be earned from the available future tasks, based on the number of available future tasks and average wage per task earned by the crowdworker for submitted tasks. In an embodiment, the crowdworker-widget utilizes below equation to determine the estimated wages from the available future tasks:

Estimated wages from the available future tasks=Number of available future tasks*Average wages per task for the submitted tasks (2)

For example, for requestor-1, the crowdworker-widget determines the estimated wages from the available 10 future tasks as $15 (i.e., 1.5*10). Similarly, estimated wages may be determined for all the requestors.

Similarly, the crowdworker-widget may determine estimated time available to attempt the future tasks, based on the number of available future tasks and time taken per task for the submitted tasks as:

Estimated time to attempt available future tasks=Number of available future tasks*Average time per task for the submitted tasks (3)

In an alternate embodiment, the crowdworker-widget may pull the information pertaining to the number of the future tasks available for attempt from the crowdsourcing platform server 104 and may subsequently determine the wages for the available future tasks by using equation (2). Similarly, estimated time to attempt the available future tasks may be determined by using equation (3).

It will be apparent to a person skilled in the art that various other combinations of the predicted task information, not explicitly disclosed in Table 4, may also be determined by the crowdworker-widget. For example, for each of the requestors, the crowdworker-widget may determine estimated hourly, daily, weekly, or monthly wages that can be earned from the available future tasks. Alternatively, hourly, daily, weekly, or monthly wages can be estimated for a particular type of the task.

### Determination of the Predicted Task Information Pertaining to the One or More Crowdsourcing Platforms

Based on the historical task information pertaining to the one or more crowdsourcing platforms, the crowdworker-widget may determine the predicted task information pertaining to the one or more crowdsourcing platforms. In an embodiment, for each of the crowdsourcing platforms that the crowdworker has worked for, the crowdworker-widget may determine count of the one or more future tasks available for attempt, types of the one or more future tasks available for attempt, estimated time to attempt the one or more future tasks, and estimated wages that can be earned from the one or more future tasks. In an embodiment, the crowdworker has worker on three crowdsourcing platforms (in conjunction with Table 3). In such a scenario, Table 5 provided below illustrates the predicted task information pertaining to the three crowdsourcing platforms, as determined by the crowdworker-widget, (in conjunction with Table 3):

TABLE 5

| | | Estimated time | |
|---|---|---|---|
| | Estimated number | available for | Estimated wages |
| | of available future | attempting future | from available |
| Platform | tasks | tasks (mins) | future tasks |
| CP-1 | 15 | 150 | 15 |
| CP-2 | 20 | 160 | 30 |
| CP-3 | 25 | 150 | 50 |

It will be understood by a person skilled in the art that number of future tasks available for attempt may be determined in a similar way, as described in conjunction with equation (2). For example, the number of available future tasks for CP-1 may be determined as (assuming that the crowdworker had accepted 100 tasks on the CP-1): Number of available future tasks=100−85=15.

In a similar way, estimated wages that can be earned from the available future tasks and estimated time to complete the available future tasks may be determined using the equations (2) and (3), respectively.

It will be apparent to a person having ordinary skills in the art that various combinations of other information, not explicitly disclosed in Table 5, may also be determined by the crowdworker-widget. For example, for each of the crowdsourcing platforms, the crowdworker-widget may determine hourly, daily, weekly, or monthly wages that can be earned from the available future tasks. Alternatively, hourly, daily, weekly, or monthly wages can be estimated for a particular type of the task. Based on the predicted task information pertaining to the one or more crowdsourcing platforms, the crowdworker may decide strategies for attempting the future tasks (e.g., for which crowdsourcing platforms to work for, which type of tasks to attempt, and so forth).

In an embodiment, the predicted task information, as disclosed above, may be determined for both the modes, i.e., the individual mode and the collective mode.

In an embodiment, in the collective mode, the crowdworker may be presented with various options in terms of comparison of the crowdworker with other crowdworkers. The crowdworker-widget may present the various types of the predicted task information, as disclosed above, with an option for the crowdworker to challenge the other crowdworkers. For example, the crowdworker may challenge the other crowdworkers in terms of time required to complete the one or more future tasks. For instance, the crowdworker completes the one or more tasks in 1 hour. The crowdworker may throw a challenge to the other crowdworkers to complete the one or more future tasks in less than 1 hour. In an embodiment, the challenge may pop-up as a notification in the crowdworker-widget. The other crowdworkers may then choose to accept/reject the challenge. Similarly, the crowdworker may challenge the other crowdworkers with respect to one or more other parameters associated with the task information (e.g., count of the one or more future tasks, wages associated with the one or more future tasks, etc.) while attempting the one or more future tasks. Receiving a challenge from the crowdworker may be a motivational factor for the other crowdworkers in attempting the one or more future tasks. Also, in order to accomplish the challenge, the other crowdworkers may attempt the one or more future tasks with increased concentration/focus. Thus, the overall quality of the response for the one or more future tasks improves.

At step 308, at least one of the historical task information or the predicted task information is presented on the display 208. The crowdworker associated with the worker-computing device 102 may utilize the presented historical task information or the predicted task information to gauge her performance. In individual mode, the crowdworker may track/monitor her performance. In collective mode, the crowdworker may compare her performance/earnings with the set of the crowdworkers. Thus, based on the presented historical task information or the predicted task information, the crowdworker may obtain sufficient information to decide which requesters/platforms to work for, what types of tasks to opt for, etc. Accordingly, the crowdworker may determine strategies for selecting/attempting one or more future tasks. An illustration of the presentation of the historical task information and the predicted task information has been discussed in conjunction with FIG. 5.

FIG. 4 is a flowchart 400 illustrating a method for determining historical task information, in accordance with at least one embodiment. The historical task information determined in the flowchart 400 corresponds to the time taken by the crowdworker to attempt the one or more tasks. Though, the time taken has been illustrated for “accepted and submitted” types of tasks, it will be apparent to a person having ordinary skill in the art that similar determination can be made for other categories of the tasks (i.e., “accepted and returned”, “accepted but not returned”, etc.).

At step 402, the crowdworker-widget monitors the worker-computing device 102 for a new session by the crowdworker. In an embodiment, the new session may correspond to logging in the one or more crowdsourcing platforms through the UI or the client application, as disclosed in the FIG. 1.

At step 404, the crowdworker-widget determines whether a new task has been attempted by the crowdworker. As disclosed in the description of FIG. 3, the programmable APIs may keep a track on new tasks attempted by the crowdworker, submission of already attempted tasks of the crowdworker, tasks returned by the crowdworker and so forth. In case, a new task has been attempted by the crowdworker, step 406 in performed else, step 408 is performed.

At step 406, a time T₁ is determined. In an embodiment, the time T₁ is equal to the acceptance time of the new task.

At step 408, a time delay can be introduced for further monitoring. In case, the crowdworker-widget has not observed any new task, it may introduce a pre-defined time delay, after which it again monitors for the new task attempted by the crowdworker.

At step 410, the crowdworker-widget keeps a track for the submission of the attempted task. In case, the crowdworker-widget observes that the attempted task has been submitted by the crowdworker, the step 412 is performed.

It will be apparent to a person having ordinary skill in the art that in case, the attempted task is not submitted by the crowdworker (step not shown in the FIG. 4), the crowdworker-widget may monitor for other actions such as return of the attempted task, time-out of the attempted task and so forth.

At step 412, a time T₂ is determined by the crowdworker-widget. In an embodiment, the time T₂ is the submission time of the attempted task.

At step 414, the crowdworker-widget presents an option to override the determined submission time to the crowdworker. In case the crowdworker wants to edit the data (e.g., due to many interruptions taken by the crowdworker while performing the task), step 416 is performed else, the step 418 is performed.

At step 416, the crowdworker may manually provide the submission time (i.e., T₂). For example, the crowdworker may adjust the time as per the breaks or interruptions taken by her.

At step 418, a task time is determined. In an embodiment, the task time is determined as the difference between the time T₂ and T₁, i.e.:

Task time=T₂−T₁ (4)

At step 420, the crowdworker-widget observes for any deviation in the determined task time. In an embodiment, the crowdworker-widget compares the determined task time with the average of the task times for already performed tasks. In case, the crowdworker-widget observes that the determined task time is an outlier (i.e., it is substantially different from the average time of all the tasks performed by the crowdworker), the step 422 is performed, else step 424 is performed. In an embodiment, the deviation of the task time from the average time for the already attempted tasks that will be considered an outlier may be defined by the crowdworker.

At step 422, the crowdworker is prompted to the edit the determined task time. Based on the breaks or interruption taken by the crowdworker, the crowdworker may edit the task time. On being prompted for editing the task time, the crowdworker has various options to choose from (e.g., the crowdworker may accept the task time as determined by the crowdworker-widget or the crowdworker may himself provide the task time).

At step 424, the task time is stored in the memory 204. The task time is stored as the historical task information. In an embodiment, the task time is stored in the database server 106.

FIG. 5 is a block diagram 500 illustrating the historical task information and the predicted task information in the crowdworker-widget, in accordance with at least one embodiment. The block diagram 500 includes a crowdworker-widget 502. The crowdworker-widget 502 includes a clock utility 504 and a settings button 506. Further, the crowdworker-widget 502 includes various submit buttons 508a-d corresponding to the options for displaying the historical task information and the predicted task information. It will be apparent to a person having ordinary skill in the art that the crowdworker-widget 502 illustrated in the block diagram 500 may include many types of different options (through submit buttons, icons, scroll bars, dialogue boxes, pull-down menus, pop-up windows, etc.) and various combinations of the historical task information and the predicted task information, not explicitly illustrated in the FIG. 5.

The clock utility 504 may be used by the crowdworker to track the one or more tasks. In an embodiment, the clock utility 504 includes three buttons, as depicted in FIG. 5: start button 504A, pause button 504B, and the stop button 504C. The crowdworker may utilize these buttons to track the one or more tasks. For example, the crowdworker, using the worker-computing device 102, may hit the start button 504A to start the tracking and may hit the stop button 504C to stop tracking. Further, in an embodiment, the clock operates in two modes: session mode and task mode. The session mode may be used by the crowdworker to track the time spent per session, whereas the task mode may be used by the crowdworker to track the time spent per task.

The settings button 506 included in the crowdworker-widget 502 may be used by the crowdworker to select one or more preferences. For example, using the settings button 506, the crowdworker may specify the default view for the crowdworker-widget 502 (e.g., view that the crowdworker sees after initializing the crowdworker-widget 502). Display options for the historical and predicted task information may also be selected by the crowdworker, using the settings button 506. For example, it may be selected whether the historical or predicted task information is to be displayed in tabular forms or graphical forms. Various options may be included in the graphical form (e.g., histograms, bar-charts, pie-charts, bubble-charts, and so forth). Further, the data to be included in each of the display (i.e., the tabular and graphical) may also be selected by using the settings button 506. For example, the crowdworker may choose to include only historical task information pertaining to the time and wages and the predicted task information corresponding to the wages only. Units to be displayed for the information may also be customized (e.g., seconds or minutes for the information pertaining to the time and rupee or dollar for the information pertaining to the wages). Further, the crowdworker may specify the time-interval for which the historical or predicted task information will be presented to the crowdworker. For example, the crowdworker may select whether the various types of the information pertaining to the requesters, as disclosed in conjunction with FIG. 3, needs to be determined and presented for hourly, daily, weekly, or monthly basis. In addition, using the settings button 506, the crowdworker may opt for the individual mode or the collective mode. Further, the user may specify the names of the one or more crowdworkers to define the set of crowdworkers, as discussed in conjunction with FIG. 3. It will be apparent to a person skilled in the art that the settings button 506 may provide various other options, not explicitly discussed above, as are included in any standard setting interface for a widget, that are known in the art.

The submit buttons 508a-d illustrate the buttons available in the crowdworker-widget 502 that the crowdworker may use to display different combinations of the historical task information and the predicted task information. For example, as depicted in the FIG. 5, the crowdworker may use the submit button 508A to display the historical task information corresponding to the task completion time for different crowdsourcing platforms. As discussed in FIG. 3, the crowdworker may simultaneously work on many crowdsourcing platforms and the crowdworker-widget 502 may collect the information for the various tasks performed on these crowdsourcing platforms through the worker-computing device 102. In an embodiment, once the crowdworker clicks the submit button 508a, a graphical trend corresponding to the time spent by the crowdworker may be displayed. Further, as is depicted in the FIG. 5, the time taken by the crowdworker (depicted on Y-axis) for the one or more tasks (depicted on the X-axis) have been displayed for four crowdsourcing platforms (i.e., CP1, CP2, CP3, and CP3). It will be apparent to a person having ordinary skill in the art that the information depicted through the submit button 508a may include the information for the set of crowdworkers, if the crowdworker has enabled the collective mode, as disclosed in FIG. 3.

In a similar way, it can be observed from FIG. 5 that the crowdworker-widget 502 may display other types of historical and predicted task information. In an embodiment, the information displayed may be in various formats, such as a graphical form (e.g., pie-charts, bar-graphs, line-charts, etc.) or a tabular form. As depicted by 508D, the predicted information corresponding to the requesters R1, R2, R3, and R4 is presented in a tabular form. As depicted, the predicted task information 508D includes miscellaneous information, such as number of available future tasks for different requesters (i.e., R1, R2, R3, and R4), estimated time to complete the future tasks, estimated time per future task, estimated wages from the future tasks, estimated earnings per future task and so forth. The crowdworker may use these combinations of the information presented on the crowdworker-widget 502 to select the one or more future tasks, as discussed in conjunction with FIG. 3.

In an alternate embodiment, the crowdworker may input one or more target parameters to the crowdworker-widget 502. In an embodiment, the one or more target parameters correspond to at least one of a target wage, or a time duration for which the crowdworker wants to work on the one or more future tasks. In such a scenario, the crowdworker-widget 502 may utilize the historical task information (for example, depicted by 508a, 508b, and 508c) and the predicted task information (for example, depicted by 508d) to recommend a set of future tasks from the one or more future tasks, that the crowdworker may attempt to achieve the target parameters (for example, target wage).

For example, the crowdworker inputs the target parameters as 15 USD and 50 minutes. The crowdworker-widget 502 may utilize the table 508D to determine that if the crowdworker attempts 10 tasks from requestor R2, the required target parameters may be achieved, as the average time that the crowdworker consumes to attempt a task from the requestor R2 is 5 minutes, and the average wage offered by the requestor R2 is 1.7 USD. Thus, the crowdworker-widget 502 may recommend the attempt of 10 tasks from the requestor R2 to achieve the target parameters. A person having ordinary skill in the art would appreciate that various other heterogeneous combinations of the one or more available future tasks can be recommended to the crowdworker in order to achieve the required target parameters.

The disclosed embodiments encompass numerous advantages. Generally, to have a variety of choice in the work and to have a good volume of the work, the crowdworkers may choose to work on several platforms and several types of tasks. Further, the crowdworker may work for a variety of requesters. In such a scenario, crowdworker needs to have sufficient and structured information that can be utilized to gauge performance in the already performed tasks or to help the crowdworker in selecting future tasks. For example, there may be certain scenarios where the requesters pay significantly low salaries for the tasks. Alternatively, there may be scenarios where the requesters take sufficiently long time to make payments to the crowdworkers, after the crowdworkers submit the tasks, or where the requesters reject too many of the completed tasks. Similarly, it might be possible that certain types of the tasks are high earning for the crowdworkers, while certain other types of tasks are not (e.g., due to different skills of the crowdworkers for different types of the tasks). In such a scenario, providing structured information (i.e., the historical task information and the predicted task information) through the crowdworker-widget about already performed tasks and to-be performed tasks may aid the crowdworkers in gauging their performance, along with helping them in selecting the strategies to select future tasks.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for presenting the task information to the crowdworker have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for presenting a task information to a crowdworker, the method comprising:
monitoring, by one or more processors, one or more tasks performed by the crowdworker;
determining, by the one or more processors, a historical task information pertaining to the one or more tasks performed by the crowdworker, based on the monitoring;
determining, by the one or more processors, a predicted task information based on the historical task information, the predicted task information being utilizable by the crowdworker to select one or more future tasks, wherein the predicted task information comprises at least one of a count of the one or more future tasks available for the crowdworker, estimated time to attempt the one or more future tasks, or wages associated with the one or more future tasks; and
presenting, by the one or more processors, at least one of the historical task information or the predicted task information to the crowdworker.

2. The method of claim 1, wherein the historical task information pertaining to the one or more tasks corresponds to at least one of a time spent by the crowdworker on the one or more tasks, a count of the one or more tasks, wages associated with the one or more tasks, types of the one or more tasks, requesters associated with the one or more tasks, or one or more crowdsourcing platforms associated with the one or more tasks.

3. The method of claim 2, wherein the types of the one or more tasks include at least one of an image/video/text labelling/tagging/categorisation, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography, text/image analysis, directory compilation, or information search/retrieval.

4. The method of claim 2, wherein the historical task information comprises an hourly wage earned by the crowdworker from each of the one or more crowdsourcing platforms.

5. The method of claim 2 further comprising receiving, by the one or more processors, information pertaining to a reputation of the requestors from at least one of the one or more crowdsourcing platforms, plugins, or internet rating sites.

6. The method of claim 5 further comprising ranking, by the one or more processors, the requestors based on the reputation, wherein the ranking is presented to the crowdworker as the historical task information.

7. The method of claim 1, wherein the historical task information or the predicted task information is presented on a display device used by the crowdworker.

8. The method of claim 7 further comprising prompting, by the one or more processors, on the display device, the crowdworker to input the historical task information manually.

9. The method of claim 1 further comprising receiving, by the one or more processors, information pertaining to one or more tasks performed by a set of crowdworkers, wherein the set of crowdworkers is selectable by the crowdworker.

10. The method of claim 1, wherein a trend of the predicted task information is presented to the crowdworker in a graphical form.

11. The method of claim 1 further comprising receiving, by the one or more processors, one or more target parameters from the crowdworker, wherein the target parameters correspond to at least one of a wage that the crowdworker targets to earn, a time period in which the crowdworker targets to complete the one or more available future tasks, a count of the one or more available future tasks that the crowdworker wants to attempt, or one or more types of the available future tasks that the crowdworker wants to attempt.

12. The method of claim 11 further comprising providing, by the one or more processors, recommendations corresponding to the one or more available future tasks to be attempted by the crowdworker, based on the one or more target parameters and the determined predicted task information.

13. A method for transmitting a task information to one or more crowdworkers, the method comprising:
monitoring, by one or more processors, one or more tasks performed by a set of crowdworkers;
determining, by the one or more processors, a historical task information pertaining to the one or more tasks performed by the set of crowdworkers, based on the monitoring;
determining, by the one or more processors, a predicted task information based on the historical task information, the predicted task information being utilizable by the one or more crowdworkers to select one or more future tasks, wherein the predicted task information comprises at least one of a count of the one or more future tasks available for the one or more crowdworkers, estimated time to attempt the one or more future tasks, or wages associated with the one or more future tasks; and
transmitting, by the one or more processors, at least one of the historical task information or the predicted task information to the one or more crowdworkers.

14. The method of claim 13, wherein the historical task information pertaining to the one or more tasks performed by the set of crowdworkers corresponds to at least one of a time spent by the set of crowdworkers on the one or more tasks, a count of the one or more tasks, wages associated with the one or more tasks, types of the one or more tasks, requesters associated with the one or more tasks, or one or more crowdsourcing platforms associated with the one or more tasks.

15. The method of claim 13, wherein the set of crowdworkers is selectable by the one or more crowdworkers.

16. The method of claim 13 further comprising selecting, by the one or more processors, the set of crowdworkers based on contacts, of the one or more crowdworkers, on one or more social networking sites.

17. A system for presenting a task information to a crowdworker, the system comprising:
one or more processors operable to:
monitor one or more tasks performed by the crowdworker;
determine a historical task information, pertaining to the one or more tasks performed by the crowdworker, based on the monitoring;
determine a predicted task information based on the historical task information, the predicted task information being utilizable by the crowdworker to select one or more future tasks, wherein the predicted task information comprises at least one of a count of the one or more future tasks available for the crowdworker, estimated time to attempt the one or more future tasks, or wages associated with the one or more future tasks; and
present at least one of the historical task information or the predicted task information to the crowdworker.

18. The system of claim 17, wherein the historical task information pertaining to the one or more tasks corresponds to at least one of a time spent by the crowdworker on the one or more tasks, a count of the one or more tasks, wages associated with the one or more tasks, types of the one or more tasks, requesters associated with the one or more tasks, or one or more crowdsourcing platforms associated with the one or more tasks.

19. The system of claim 17, wherein the historical task information or the predicted task information is presented on a display device used by the crowdworker.

20. The system of claim 19, wherein the one or more processors are further operable to prompt, on the display device, the crowdworker to manually input the historical task information.

21. A system for transmitting a task information to one or more crowdworkers, the system comprising:
one or more processors operable to:
monitor one or more tasks performed by a set of crowdworkers;
determine a historical task information, pertaining to the one or more tasks performed by the set of crowdworkers, based on the monitoring;
determine a predicted task information based on the historical task information, the predicted task information being utilizable by the one or more crowdworkers to select one or more future tasks, wherein the predicted task information comprises at least one of a count of the one or more future tasks available for the one or more crowdworkers, estimated time to attempt the one or more future tasks, or wages associated with the one or more future tasks; and
transmit at least one of the historical task information or the predicted task information to the one or more crowdworkers.

22. A computer program product for use with a computer, the computer program product comprising a non-transitory computer readable medium, wherein the non-transitory computer readable medium stores a computer program code for presenting a task information to a crowdworker, wherein the computer program code is executable by one or more processors to:
monitor one or more tasks performed by the crowdworker;
determine a historical task information, pertaining to the one or more tasks performed by the crowdworker, based on the monitoring;
determine a predicted task information based on the historical task information, the predicted task information being utilizable by the crowdworker to select one or more future tasks, wherein the predicted task information comprises at least one of a count of the one or more future tasks available for the crowdworker, estimated time to attempt the one or more future tasks, or wages associated with the one or more future tasks; and
present at least one of the historical task information or the predicted task information to the crowdworker.

23. A computer program product for use with a computer, the computer program product comprising a non-transitory computer readable medium, wherein the non-transitory computer readable medium stores a computer program code for transmitting a task information to one or more crowdworkers, wherein the computer program code is executable by one or more processors to:
monitor one or more tasks performed by a set of crowdworkers;
determine a historical task information, pertaining to the one or more tasks performed by the set of crowdworkers, based on the monitoring;
determine a predicted task information based on the historical task information, the predicted task information being utilizable by the one or more crowdworkers to select one or more future tasks, wherein the predicted task information comprises at least one of a count of the one or more future tasks available for the one or more crowdworkers, estimated time to attempt the one or more future tasks, or wages associated with the one or more future tasks; and
transmit at least one of the historical task information or the predicted task information to the one or more crowdworkers.
